(19) United States
(12) Patent Application Publication
(10) Pub. No.: US 2012/0147721 A1
(43) Pub. Date: Jun. 14, 2012

(54) METHOD FOR IDENTIFYING DISC

(75) Inventor: Kuijper Maarten, Taipei City (TW)

(73) Assignee: LITE-ON IT CORPORATION, Taipei (TW)

(21) Appl. No.: 13/315,428

(22) Filed: Dec. 9, 2011

(30) Foreign Application Priority Data
Dec. 10, 2010 (CN) 201010588860.3

(51) Int. Cl. G11B 19/12

(52) U.S. Cl. 369/47.1; G9B/19.018

(57) ABSTRACT

A method for identifying a disc is provided. The method comprising steps of: controlling an optical reader to fetch content stored at a selected position and counting time period; stopping counting and acquiring an access time after receiving the error message; determining if the access time is greater than a reference time; identifying the disc as a legitimate disc when the access time is greater than the reference time; and identifying the disc as a pirate disc when the access time is less than the reference time.

This application claims the benefit of People's Republic of China application Serial No. 2010105888602.3, filed Dec. 10, 2010, the subject matter of which is incorporated herein by reference.

### FIELD OF THE INVENTION

The present invention relates to a method for identifying a disc, and more particularly to a method for identifying the disc via comparing access time or data content.

### BACKGROUND OF THE INVENTION

Being storage media for digital data, compact disc (hereinafter, CD) and digital video disc/digital versatile disc (hereinafter, DVD) discs are easily copied and duplicated, and pirate discs are very common. The spread of pirate discs infringes the profits of legitimate disc producers. To protect the legitimate discs from being illegally copied, legitimate CD/DVD producers propose several protection mechanisms so far. However, conventional data protection techniques (so called digital rights management, hereinafter, DRM) are cracked by pirate disc producers. Some of the conventional DRM techniques are discussed below.

Take compact disc read-only memory (hereinafter, CD-ROM) for instance, a mold is used for imprinting data on data layer of the legitimate disc. Logical block addresses (hereinafter, LBA) and/or physical block number (hereinafter, PBN) are commonly used for data block addressing in optical disc (e.g. CD-ROM disc or DVD-ROM disc). The following explanation uses LBA for the purpose of illustration. However, it should be noted that LBA and PBN are one-to-one mapped, and the implementation details are similar for data blocks represented in either LBA or PBN.

Varied from applications, the patterns of the mold for imprinting discs are designed differently. Therefore, some of the legitimate disc manufactures deliberately create two identical LBAs on the legitimate discs, create discontinuous LBA on the legitimate discs, or imprint un-decodable data at specific tracks for protecting the legitimate discs from being pirated.

Disc burning software is capable of detecting whether two identical LBAs exist on the source disc, or the source disc contains un-decodable data. During the process of duplicating a legitimate disc, the disc burning software automatically detects such error data and stops burning the target disc. Therefore, legitimate discs are supposedly protected from being duplicated.

However, the operation of the disc burning software can be altered as well. That is, while burning a disc, the modified disc burning software is designed to ignore the error messages such as two identical LBAs are existed etc. For the disc being burnt, the position of the second LBA of the two identical LBAs is either kept blank or replaced with dummy data (e.g. 0xFF). In other words, dummy data or blank data are used in pirate discs to replace the made-up error data on the legitimate disc.

In other words, although the disc burning software is not capable of generating two identical LBAs on the target disc, nor creates a destroyed track with un-decodable track as in the legitimate disc. Therefore, in order to finish the disc burning process, the disc burning software is designed to either ignore the second LBA among the two identical LBAs and skip recording, or replace the destroyed track with dummy data.

Although the pirate discs can be produced via recording dummy data, legitimate disc providers may further use the above characteristics to propose verification software for identifying the disc under test is legitimate or pirate.

In addition to the copyright data contained in the legitimate disc, some selected LBAs are manufactured to store destroyed data deliberately. Therefore, when a user intends to read the copyright data, the embedded verification software expects the disc player to return the error message as soon as the selected LBA being fetched. In the case, for example, that the verification software receives the expected error message from the player while the player fetches data stored at the LBA 0x1111 of the disc under test, this implies that the data stored at LBA 0x1111 on the legitimate disc are destroyed. In other words, the disc under test will be recognized as a legitimate one as the verification software receives the expected error message.

On the other hand, assume two LBAs on the legitimate disc are both assigned the address of LBA 0x1111. While acquiring the second LBA 0x1111, the optical disc player returns an error message and such behavior matches to the setting of the verification software. That is, once the verification software receives the error message as expected, the disc under test is verified to be legitimate.

Since the sector data at the LBA 0x1111 are not destroyed in the pirate disc, the optical reader successfully fetches the dummy data stored at the LBA 0x1111 instead of generating error message, In other words, when the optical reader operates normally without returning error message to the verification software, the disc under test can be identified as the pirate disc.

However, in order to crack the data protection mechanism that generates error message at certain selected address while accessing the legitimate disc. Some pirate disc producers further use daemon software for assistance. The daemon software is used for generating a fake error message and fooling the verification software. Simply speaking, the daemon software records the position of the selected LBAs having error data, stores related information, and generates corresponding fake error message when the verification software attempts to access the selected LBAs.

Although the pirate disc is not capable of imitating identical data content in the legitimate disc, it can be used together with the daemon software. While accessing the pirate disc, the daemon software is capable of generating and transmitting a fake error message to the verification software. By doing so, even if the disc under test is actually a pirate one, the verification software is confused by the fake error message and mistakenly identifies the disc under test as a legitimate one.

In other words, during the optical reader's access of the pirate disc, the verification software expects to receive the error message when the optical reader attempts to acquire the data stored at the selected LBA. However, the error message received by the verification software is not generated by the optical reader but the daemon software. Receiving the fake message results in that the verification software mistakenly identifies the pirate disc to be legitimate.

In short, conventional DRM mechanisms use the verification software to verify the disc is legitimate or pirate according to the content of the message being returned. That is, whether the return message of the optical reader matches to an expected message. However, such approaches are cracked by utilizing daemon software and pirate discs together, and this implies that further improvement is necessary to distinguish legitimate and pirate discs.

### SUMMARY OF THE INVENTION

An embodiment of the present invention provides a method for identifying a disc, wherein a selected position is located on a data track of the disc, and an optical reader generates an error message while fetching content stored at the selected position, the method comprising steps of: controlling the optical reader to fetch the content stored at the selected position and counting time period; stopping counting and acquiring an access time after receiving the error message; determining if the access time is greater than a reference time; identifying the disc as a legitimate disc when the access time is greater than the reference time; and identifying the disc as a pirate disc when the access time is less than the reference time.

Another embodiment of the present invention provides a method for identifying a disc, wherein a selected position is located on a data track of the disc, wherein two logical blocks are ahead and behind the selected position respectively, and each of the two logical blocks is assigned with a first block address, the method comprising steps of: controlling an optical reader to forward seek along the data track and fetching a first content stored at a front first block address among the two first block addresses, wherein the front first block address is relatively closed to the inner disc; proceeding a track jumping operation, for controlling the optical reader to jump to another block address behind the two first block addresses; controlling the optical reader to backward seek and fetching a second content stored at a rear first block address among the two first block addresses, wherein the rear first block address is relatively closed to the outer disc; comparing the first content and the second content; identifying the disc as a legitimate disc when the first content and the second content are different and identifying the disc as a pirate disc when the first content and the second content are identical.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic view representing a disc using data tracks to store data;

FIG. 1B is a schematic view showing continues LBA on the disc;

FIG. 2A is a schematic view illustrating the method for identifying the disc by creating a destroyed logical block data at continuous LBA of the disc;

FIG. 2B is a flow chart illustrating the method for identifying the disc corresponding to the verification software demonstrated in FIG. 2A;

FIG. 3A is a schematic view illustrating the method for identifying the disc under test is legitimate or not by assigning a duplicated LBA on the disc;

FIG. 3B is a flow chart illustrating the method for identifying the disc corresponding to the verification software demonstrated in FIG. 3A;

FIG. 4 is a table listing the radiuses of a DVD disc having multiple integer number of DVD ECC blocks and corresponding LBAs; and

FIG. 5 is a schematic view illustrating the data track located at 38.3 millimeter radius on the disc.

### DETAILED DESCRIPTION OF PREFERRED EMBODIMENTS

Referring to the background, it should be noted that the disc burning software is not as flexible as imprinting, and it can barely duplicate identical data on the pirate disc. In other words, the optical player does not generate error message while acquiring data at the selected LBAs. However, with the help of the daemon software, the verification receives the fake error message and misjudges the pirate disc to be legitimate.

Therefore, the present invention proposes two different approaches for solving such problem. The commons of these two embodiments is to provide the disc with different data layout, accompanied with suitable verification software.

The first embodiment according to the present invention refers to the access time for fetching destroyed data blocks. That is, to create data tracks not meet the specification intentionally by imprinting un-decodable or destroyed data at the selected position on the legitimate disc. When the verification software orders the optical reader to fetch data content stored at the selected position, the access time between sending the reading command and receiving the error message is counted. The access time is used to identify whether the disc under test is legitimate or pirate. In other words, if the access time is relative long, the disc under test is legitimate. When the pirate disc is used together with the daemon software, the access time is relatively short because the fake error message is generated via the daemon software's imitation. In other words, the generation of the fake error message is quick and the verification software does not need to wait for the optical reader to response. Since the access time is shorter than the expected reference time, the disc under test would be identified to be pirate.

The second embodiment according to the present invention refers to the comparison of access time or data content. That is, to imprint data tracks mismatching to the specification at a selected position. For example, assign identical LBAs to continuous LBAs while these identical LBAs store distinguishable data content. Similarly, for PBN, the identical physical block number (hereinafter, PBN) is assigned to two continuous PBNs. During practical operation, the optical reader is controlled to perform track jumping, following, and then to fetch data content stored at the continuous LBAs. After that, the verification software compares the fetched data content. If the data content are different, the disc under test is identified to be legitimate and vice versa.

To further illustrate the approaches according to the present invention, more details are disclosed below. In short, the present invention employs the access time and data content comparison to identify if the disc under test is legitimate or not. The two embodiments below consider the access time of the disc under test regarding two different data patterns.

The first embodiment considers the access time for LBAs having destroyed data. The second embodiment discusses the access time of the contiguous data blocks having identical LBAs as well as the comparison of the data content stored at these identical LBAs. However, the present invention is not limited to the two embodiments but capable of being used in other applications.

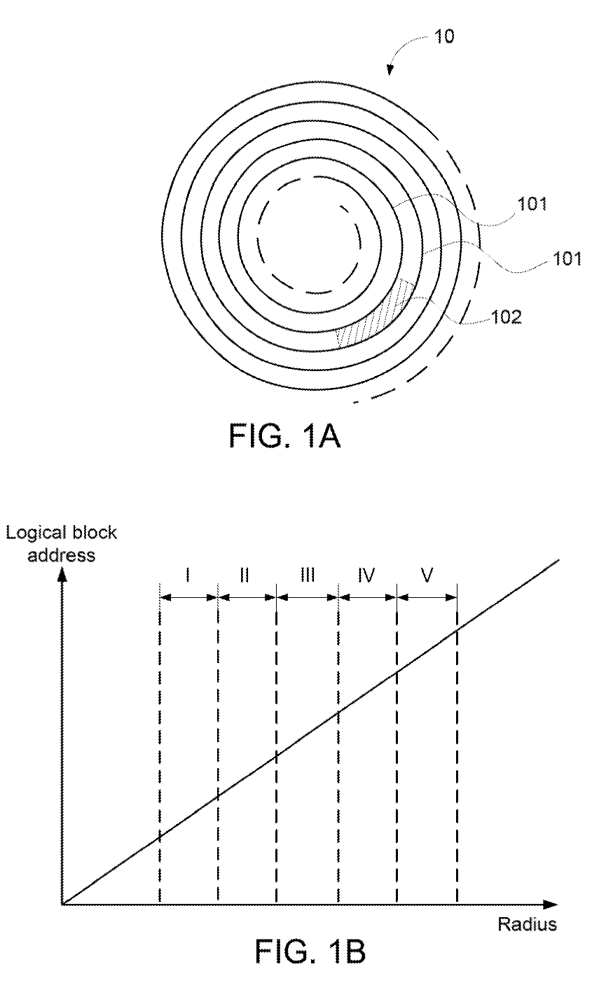

FIG. 1A is a schematic view representing a disc using data tracks to store data, optical discs such as CD, DVD use spiral tracks to store data, where in the spiral tracks extend from inside to outside of the disc. To simplify the step of data access flow, the data tracks 101 of the disc are partitioned as a plurality number of blocks 102. In order to identify the data blocks, each data block is assigned with/mapped to a unique address. As the addressing approaches may vary, the data blocks on the disc 10 can be accessed differently. For example, LBA is a typical approach for accessing data blocks on the disc.

FIG. 1B is a schematic view showing continues LBA on the disc. In general, the numbering of LBA is increasing. That is, the LBA starts from a first LBA I, a second LBA II, a third LBA III, a fourth LBA IV, a fifth LBA V and so on. Therefore, while fetching data, the optical reader continuously fetches data blocks incrementally.

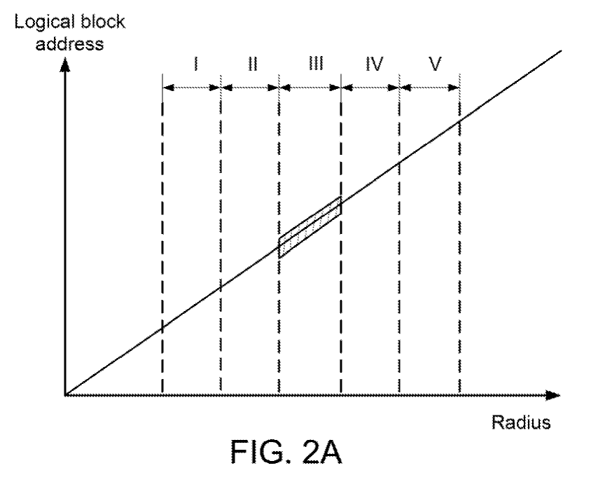

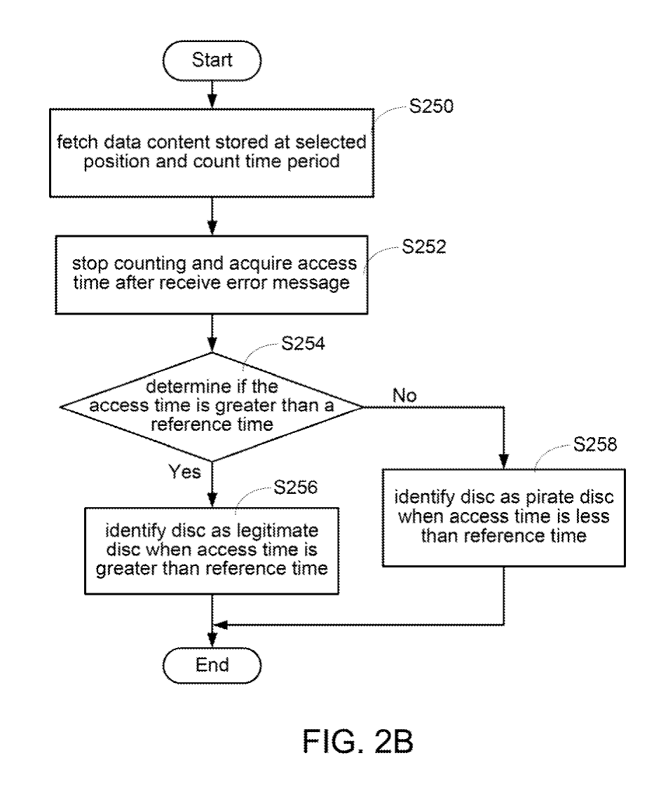

FIG. 2A is a schematic view illustrating the method for identifying the disc by creating a destroyed logical block data at continuous LBA of the disc. Therefore, the address arrangement of the LBAs is in the order of the first LBA I, the second LBA II, the third LBA III, the fourth LBA IV, the fifth LBA V and so on. Among them, data content stored at the third LBA was destroyed intentionally during manufacture and is impossible to be acquired nor decoded successfully.

While the optical reader seeks along the data track and fetches data content in the LBAs sequentially, the optical reader is not able to access the third LBA III smoothly after the fetching of data content stored at the first LBA I and the second LBA II. The discontinuous fetching of the optical reader is resulted from that the data content stored at the third LBA III was destroyed during manufacture. Therefore, if the optical reader attempts to fetch the data stored at the third LBA III, an error message is generated and passed to a host (e.g. a personal computer) only after the optical reader attempts a few times of fetching data stored at the third LBA III.

As the optical reader automatically retries to access the third LBA III for several times, and it cost extra time for the host to receive the error message. The actual duration caused by the optical reader to retry thus becomes the reference for comparison.

It should be noted that, instead of duplicating the destroyed data in the legitimate disc, dummy data are used for replacement in the pirate disc. In other words, the third LBA III in the pirate disc does not actually contain un-decodable data. Therefore, when the optical reader fetches data stored at the third LBA III of the pirate disc, the optical reader does not need to retry to access the third LBA III but successfully retrieves the dummy data. Consequently, the optical reader does not generate error message nor pass it to the host. Instead, the daemon software is the one generates and passes the fake error message to the host for cheating the verification software.

In other words, the legitimate disc according to present invention contains data content that is not able to be accessed at the selected position. When the optical reader is controlled to move to the selected position, it has to repeatedly retry and consequently starts some mechanical control processes such as track jumping, track following etc. Compared with the normal fetching process, such mechanical control processes take more time. On the other hand, if the error message is fake and generated by the daemon software, the mechanical control processes are skipped and the fake error message is returned immediately. Therefore, the access time for the pirate disc becomes shorter than the access time for the legitimate disc.

In other words, the verification software pre-stores the selected positions on the legitimate discs in advance. When the verification software controls the optical reader to access the selected position for fetching data in practical application, the verification software is supposed to receive the error message from the optical reader. However, the error message itself is not used for identifying whether the disc is legitimate or not. In fact, the verification software identifies whether the disc under test is legitimate or not according to the duration for receiving the error message.

Therefore, a reference time representing the standard duration for accessing the legitimate disc with such data is pre-stored in the verification software and used for comparison in practical application. After the read command is sent, the disc under test is identified to be legitimate if the access time is greater than or equal to the reference time. On the other hand, if the access time is less than the reference time, the disc under test is identified to be pirate. In addition, it should be noted that the comparisons between the access time and the reference time may exist some differences in practical applications.

FIG. 2B is a flow chart illustrating the method for identifying the disc corresponding to the verification software demonstrated in FIG. 2A. First, the optical reader is controlled to fetch the data content stored at the selected position and a timer starts to count the time period (step S250). After the error message is received, the timer stops counting hence an access time is acquired (step S252). After the access time is received, compare the access time to a reference time to determine whether the access time is greater than the reference time (step 254), If the access time is greater than the reference time, the disc under test is identified as a legitimate disc (step S256). On the other hand, if the access time is less than the reference time, the disc under test is identified as a pirate disc (step S258).

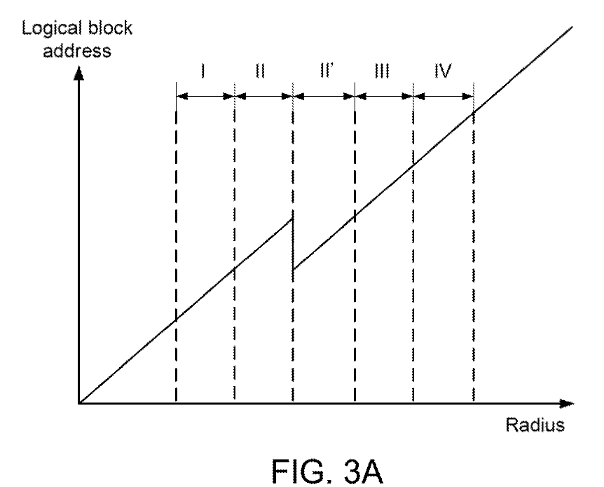

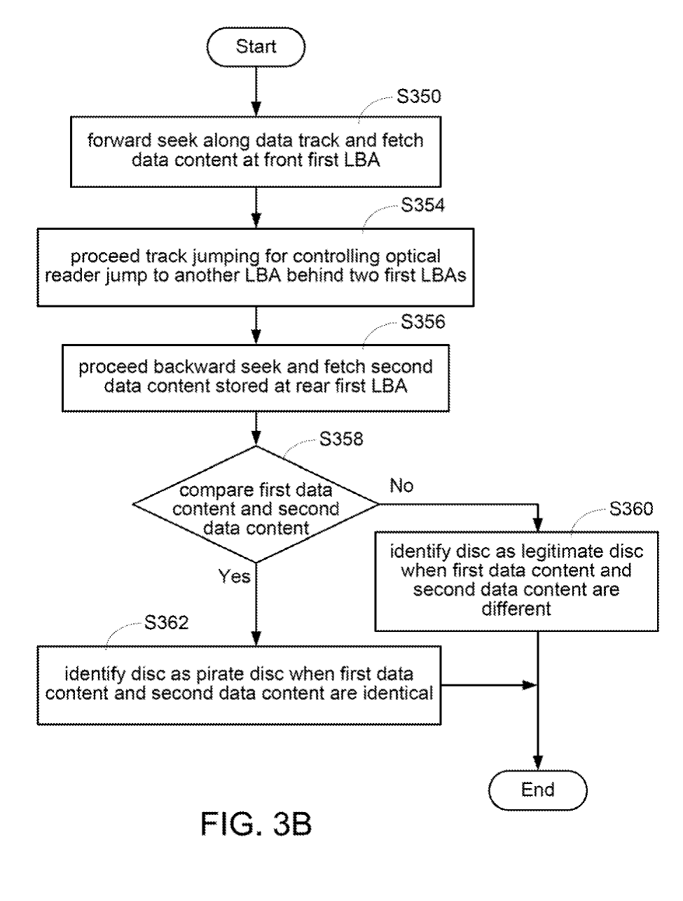

FIG. 3A is a schematic view illustrating the method for identifying the disc under test is legitimate or not by assigning a duplicated LBA on the disc. Compared with FIG. 1B, it should be noted that the legitimate disc in FIG. 3A is assigned with two identical LBAs, and the data contents stored at the two identical LBAs are different.

For example, the third LBA III in FIG. 1B is replaced by the rear second LBA II′ in FIG. 3A. The data content stored at the front second LBA II and the rear second LBA II′ are different. The rear second LBA II′ is also followed by a third LBA III, a fourth LBA IV and so on. In other words, the front second LBA II, and the rear second LBA II′ are both assigned with the second LBA.

Among these two second LBAs, the front second LBA II is relatively closed to the inner disc under test, and the rear second LBA II′ is relatively closed to the outer disc. Besides, the data contents stored at the two second LBAs are different.

Since the optical reader is designed to fetch data content in sequential order, the optical reader is controlled to access the third LBA III after the data content stored at the second LBA II are received. In an ideal case, the optical reader fetches data content in the sequence of the front second LBA II, the rear second LBA II′, and the third LBA III.

However, when the optical reader accesses the rear second LBA II′, as the assigned address of the rear second LBA II′ is the same as that of the front second LBA II, the optical reader considers an unexpected situation occurs. The optical reader retries several times and may be an error message is generated and passed to the verification software of the host. In other words, the duration (access time) that the optical reader starts to seek data content stared at the third LBA III until the error message is received by the host is used for comparing with the reference time in the present invention.

Referring to the background, it is explained that the pirate copy of the legitimate disc in FIG. 3A is not capable of having two identical LBAs but dummy data are used for replacement. In short, the pirate disc does not contain the rear second LBA II′. After fetching data content stored at the front second LBA II, if the optical reader is capable of continuously accessing the third LBA III in the pirate disc.

While accessing the pirate disc, the optical reader does not have to retry to read the dummy data nor send error message as in fetching data stored at the legitimate disc. Instead, the daemon software is used for transmitting fake error messages to the verification software.

As the duration of generating the error messages of the legitimate and pirate discs are distinguishable, such characteristics can be used to identify the copyright of a disc under test. In short, when the disc under test is a pirate one, the access time is much shorter than the legitimate disc. In a case of the pirate disc, the error message is generated and transmitted by the daemon software, not the optical reader. The response from the daemon software is instantaneous and much shorter than the mechanical movements of the optical reader. This implies that the magnitude of the access duration cost by the optical reader is several orders greater than the message generation from the daemon software. Therefore, the legitimate disc in FIG. 3A can be identified according to the verification software in FIG. 2A.

In addition, FIG. 3A provides another aspect of identifying the copyright of a disc. Basically, the main concept is to compare the data contents stored at LBAs ahead and behind a selected position. The LBAs ahead and behind the selected position are assigned with different data contents but the same address. The two LBAs are fetched at different time point, and their data contents are used for comparisons.

Although the two LBAs are assigned with an identical LBA, it should be noted that the data content stored at the LBA ahead the selected position (the front second LBA II) is different from the ones stored at the LBA behind the selected position (the rear second LBA II′). Based on such design of data contents and LBAs, the verification software is capable of identifying the copyright of the disc under test.

Whether a disc under test is legitimate disc can be identified according to the verification flow shown in the FIG. 3B as well.

FIG. 3B is a flow chart illustrating the method for identifying the disc corresponding to the verification software demonstrated in FIG. 3A. It should notice that, the legitimate disc provides two first LBAs according to this embodiment. Among the two first LBAs, the front first LBA is located relatively closed to inner disc, and the rear first LBA is located relatively closed to outer disc.

First of all, the optical reader is controlled to proceed forward seeking along the data track. The optical reader first fetches a first data content stored at the front first LBA. After successfully fetching data content stored at the front first LBA, the optical reader is not able to fetch the rear first LBA.

After the data content stored at the front first LBA is read, the optical reader will be controlled to do a track jumping operation, to jump to another LBA behind the two first LBAs (step S354). After that, the optical reader is controlled to backward seek and fetch second data content stored at the rear first LBA (step S356). The first data content and the second data content are further compared (step S358). When the first data content and the second data content are different, the disc under test is identified as a legitimate disc (step S360). On the other hand, if the first data content and the second data content are identical, the disc under test is identified as a pirate disc (step S362).

While accessing the legitimate disc in FIG. 3A, the verification software first controls the optical reader to forward seek along the data track and fetch the first data content stored at the front second LBA II on the disc. After the first data content stored at the front second LBA is fetched, the optical reader continues to read the next LBA, that is, the rear second LBA II′. However, it is unusual to have two identical LBAs (the front second LBA II and the rear second LBA II′) simultaneously, and the error condition is encountered by the optical reader. In a case of the legitimate disc, the reading process is stopped by this error condition.

After the first data content stored at the front second LBA II is received, a track jump operation is then performed for accessing data stored at the LBAs proceeding the rear second LBA II′, e.g. the third LBA III, the fourth LBA IV etc. After that, the optical reader will be controlled to do a backward seek operation, and fetches the second data content stored at the rear second LBA II′. The first and the second data contents are used for comparing, and the comparing result is used for identifying the disc under test is legitimate or pirate. If the data contents of the front and rear second LBAs are different, the disc under test is identified to be legitimate.

As for the pirate disc, the optical reader proceeds a forward seek operation, and fetches the first data content stored at the second LBA II along the data track. Since the pirate disc contains no second LBA II′, the optical reader is not capable of fetching the rear second LBA II′ after the first data content is acquired.

Afterwards, the optical reader is controlled to precede a track jump operation. The optical reader performs a jumping operation and being moved to an arbitrate LBA closer to outer disc, e.g. the third LBA III, the fourth LBA IV, etc. In addition, the optical reader is controlled to proceed a backward seek operation and fetches the second data content stored at the second LBA.

As the pirate disc does not contain the rear second LBA II′, the optical reader still acquires the first data content stored at the same second LBA II via backward seek. When the first data content is received twice, the disc under test is identified to be pirate.

While the optical reader proceeds backward seeking, sometimes it is not precisely moved to the exact position of the start of the rear second LBA II. Therefore, the embodiment according to the present invention proposes conditions for the selection of position on the data tracks.

In order to avoid fetching data incorrectly on the data track, error correction code (hereinafter, ECC) are used for every a certain length of data tracks. The certain length of data tracks is named as an ECC block. According to the present invention, the data track having integer number of ECC blocks makes the access of the optical reader relatively efficient.

According to the specification of DVD, each ECC block in the DVD comprises 16 data sections/blocks and each data section/block contains 2048 bytes of data. In other words, each ECC block is corresponding to a length of 8.2 centimeter after conversion. It is no doubt that such information can also be calculated for other types of disc (e.g. VCD etc). The details of the calculation are as follows.

According to the specification of DVD-ROM, each sector is assigned with a sector ID for 12 bytes, and an error detection code (hereinafter, EDC) for 4 bytes. The combination of the 16 bytes for the sector ID and EDC, and a 4,832 bytes of ECC code becomes a complete ECC block. Therefore, an ECC block contains 16*(12+2,048+4)+4,832=37,856 bytes of data. Via an eight-to-fourteen modulation plus decoder (hereinafter, EFMplus), the 37,856 bytes of data are transformed from the 8-bits length code to 16-bits length code. Therefore, 37,856*16=605,696 channel bits are retrieved correspondingly. In addition, extra 32 bits are appended to every 1,456 bits of channel bit for synchronization Therefore, the number of channel bits contained in each ECC block is equal to 605,696+(605,696/1,456)*32=619,008 bits. According to the specification of DVD-ROM, the length of each channel bit is 0.133 micrometer in a single layer DVD disc. Therefore, the length of an ECC block on a single layer DVD disc is approximately 619,008*0.133 micrometer, that is, around 8.2 centimeter.

As the length of ECC blocks on the data track can be calculated. The present invention based on this calculation and find out perimeters of which data tracks consisting of integer number of ECC blocks. Via the formula between the radius and the perimeter, the radiuses suitable for the selected positions in the present invention are recognized.

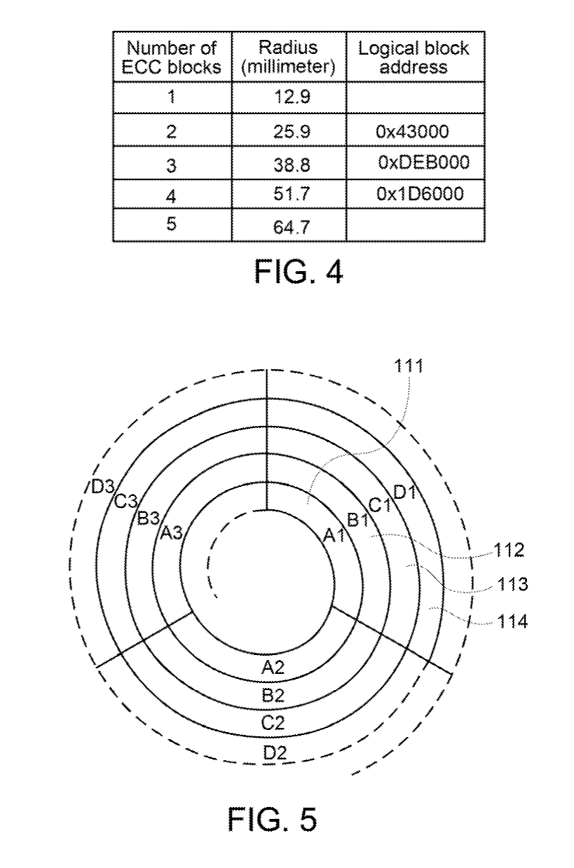

FIG. 4 is a table listing the radiuses of a DVD disc having multiple number of DVD ECC blocks and corresponding LBAs. According to FIG. 4, the backward seek of the optical reader becomes more precise if the radius of the selected position in the embodiment is set as 25.9 millimeter (LBA 0x43000), 38.3 millimeter (LBA 0xDEB000), or 51.7 millimeter (LBA 0x1D6000). In other words, the selection of the selected position is ideally located at data tracks comprising integer number of ECC blocks. The length of each ECC block is approximately 8.2 centimeter and it is possible to refer this information to estimate the ideal location of the selected position.

For example, according to FIG. 5, the circumference of the data track at radius 38.3 millimeter 112 is equal to three times of the length of three ECC blocks, ECC B1, ECC B2 and ECC B3. The number of ECC blocks contained in the data tracks 111, 113, 114 is approximately three ECC blocks. For instance, the data tracks shown in FIG. 5 are closed to the data track 112, and contain data tracks A1 to A3, C1 to C3, and D1 to D3 respectively. Therefore, as the data tracks are tightly closed to each other, the position of ECC blocks contained in each data track tend to be aligned. Therefore, while the optical reader precedes a backward seeking operation, it does not need to seek the selected position gradually but jump cross the data tracks to inner part of the disc.

Therefore, the present invention proposes special designed data content while imprinting discs and provides verification software for assistance. The method proposed in the present invention for identifying whether the disc is a legitimate or pirate one is efficient and accurate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for identifying a disc, wherein a selected position is located on a data track of the disc, and an optical reader generates an error message while fetching content stored at the selected position, the method comprising steps of:
controlling the optical reader to fetch the content stored at the selected position and counting time period;
stopping counting and acquiring an access time after receiving the error message;
determining if the access time is greater than a reference time;
identifying the disc as a legitimate disc when the access time is greater than the reference time; and
identifying the disc as a pirate disc when the access time is less than the reference time.

2. The method for identifying a disc as claimed in claim 1, wherein the content stored at the selected position contains destroyed data and the destroyed data can not be decoded accurately.

3. The method for identifying a disc as claimed in claim 1, wherein the data track comprises integer number of error correction code (hereinafter, ECC) blocks.

4. The method for identifying a disc as claimed in claim 1, wherein the destroyed data is imprinted on the disc via a mold.

5. The method for identifying a disc as claimed in claim 1, wherein two blocks are ahead and behind the selected position respectively, and the two blocks are both assigned with an identical block address

6. The method for identifying a disc as claimed in claim 5, wherein the identical block address is represented by a logical block address (hereinafter, LBA) or an physical block number (hereinafter, PBN).

7. The method for identifying a disc as claimed in claim 5, wherein the identical block address is imprinted on the disc via a mold.

8. A method for identifying a disc, wherein a selected position is located on a data track of the disc, wherein two blocks are ahead and behind the selected position respectively, and each of the two blocks is assigned with a first block address, the method comprising steps of:
controlling an optical reader to forward seek along the data track and fetching a first content stored at a front first block address among the two first block addresses, wherein the front first block address is relatively closed to the inner disc;
proceeding a track jumping operation, for controlling the optical reader to jump to another block address behind the two first block addresses;
controlling the optical reader to backward seek and fetching a second content stored at a rear first block address among the two first block addresses, wherein the rear first block address is relatively closed to the outer disc;
comparing the first content and the second content;
identifying the disc as a legitimate disc when the first content and the second content are different and
identifying the disc as a pirate disc when the first content and the second content are identical.

9. The method for identifying the disc as claimed in claim 8, wherein the first block address is imprinted on the disc via a mold.

10. The method for identifying the disc as claimed in claim 8, wherein the selected position located at the data track comprising integer number of ECC blocks.

11. The method for identifying the disc as claimed in claim 8, wherein the first block address is represented by a logical block address (hereinafter, LBA) or an physical block number (hereinafter, PBN).
